(19) United States
(12) Patent Application Publication
(10) Pub. No.: US 2012/0329031 A1
(43) Pub. Date: Dec. 27, 2012

(54) INFORMATION DISPLAY APPARATUS AND INFORMATION DISPLAY METHOD

(76) Inventor: Takayuki UCHIDA, Kanagawa (JP)

(21) Appl. No.: 13/489,792

(22) Filed: Jun. 6, 2012

(30) Foreign Application Priority Data
Jun. 27, 2011 (JP) 2011-142257

(51) Int. Cl. G09B 7/00

(52) U.S. Cl. 434/362

(57) ABSTRACT

An information display apparatus includes a display control unit configured to control display of a question that is received and then stored; a request receiving unit configured to receive a display request to display the question; a generating unit configured to generate a schedule table in which an order of displaying questions and display durations of the respective questions are associated with each other so that a sum of the display durations of the questions becomes equal to or shorter than a question-and-answer time indicating a predetermined duration of a question-and-answer session; and a notifying unit configured to issue a notice of a timing at which each display duration ends based on the schedule table. The display control unit switches display of the questions in accordance with the order. When a predetermined condition is satisfied after the schedule table is generated, the generating unit adjusts the schedule table.

### CROSS-REFERENCE TO RELATED APPLICATIONS

The present application claims priority to and incorporates by reference the entire contents of Japanese Patent Application No. 2011-142257 filed in Japan on Jun. 27, 2011.

### BACKGROUND OF THE INVENTION

1. Field of the Invention

The present invention relates to an information display apparatus and an information display method.

2. Description of the Related Art

Conventionally, in a lecture, a conference, or a meeting at an office or a university, there has been a case that a projector as an information projecting apparatus is used to project material generated by a personal computer (PC) onto a screen while the material is printed in advance and handed out to all participants. For this, a technology related to projection for establishing a wired or wireless connection between a PC and a projector or a well-known technology for printing material from a PC have been used.

In general, when a presentation is given with reference to slideshow material of a plurality of pages by using a projector as mentioned above, a duration for the presentation is usually set in advance and a presenter is required to finish the presentation by the end of the duration. However, it is cumbersome for the presenter to keep track of time during the presentation in order to finish the presentation in time.

To make cumbersome time keeping easy, there is a proposed method as explained below. For example, a technology is disclosed in Japanese Patent Application Laid-open No. 2003-162274, in which a duration to be used for each slide is registered in advance, an elapsed time from a start of a presentation and an elapsed time for each slide are measured, and an instruction to switch between images is issued to a presenter in order to use a presentation time as scheduled.

However, in the technology disclosed in Japanese Patent Application Laid-open No. 2003-162274, in which the presentation time is used as scheduled by registering a duration to be used for each slide in advance, it is difficult to schedule a duration to be used for each question during a question-and-answer session following a slideshow presentation, and therefore, it is difficult to efficiently perform the question-and-answer session within a limited time.

Therefore, there is a need for an information display apparatus and an information display method, capable of efficiently perform a question-and-answer session within a predetermined time.

### SUMMARY OF THE INVENTION

It is an object of the present invention to at least partially solve the problems in the conventional technology.

According to an embodiment, there is provided an information display apparatus that communicates with a question input apparatus for inputting a question and includes a receiving unit configured to receive the question; a storage unit configured to store therein the question; a display control unit configured to control display of the question; a request receiving unit configured to receive a display request to display the question; a generating unit configured to, in response to the display request received by the request receiving unit, generate a schedule table in which an order of displaying questions stored in the storage unit and display durations of the respective questions are associated with each other so that a sum of the display durations of the questions becomes equal to or shorter than a question-and-answer time indicating a predetermined duration of a question-and-answer session; and a notifying unit configured to issue a notice of a timing at which each of the display durations ends based on the schedule table. When receiving a switching request to request switching between the questions, the display control unit switches display of the questions in accordance with the order indicated in the schedule table. When a predetermined condition is satisfied after the schedule table is generated, the generating unit adjusts the schedule table.

According to another embodiment, there is provided an information display apparatus that includes a first receiving unit configured to receive a question; a storage unit configured to store therein the question; a display control unit configured to control display of the question; a second receiving unit configured to receive a display request to display the question; a generating unit configured to, in response to the display request received by the second receiving unit, generate a schedule table in which an order of displaying questions stored in the storage unit and display durations of the respective questions are associated with each other so that a sum of the display durations of the questions becomes equal to or shorter than a question-and-answer time indicating a predetermined duration of a question-and-answer session; and a notifying unit configured to issue a notice of a timing at which each of the display durations ends based on the schedule table. When receiving a switching request to request switching between the questions, the display control unit switches display of the questions in accordance with the order indicated in the schedule table. When a predetermined condition is satisfied after the schedule table is generated, the generating unit adjusts the schedule table.

According to still another embodiment, there is provided an information display method that includes receiving a question; storing the question in a storage unit; controlling display of the question; receiving a display request to display the question; generating, in response to the display request received, a schedule table in which an order of displaying questions stored in the storage unit and display durations of the respective questions are associated with each other so that a sum of the display durations of the questions becomes equal to or shorter than a question-and-answer time indicating a predetermined duration of a question-and-answer session; and issuing a notice of a timing at which each of the display durations ends based on the schedule table. The controlling includes switching, when receiving a switching request to request switching between the questions, display of the questions in accordance with the order indicated in the schedule table. The generating includes adjusting the schedule table when a predetermined condition is satisfied after the schedule table is generated.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a schematic configuration example of an information display system;

FIG. 2 is a block diagram of a functional configuration example of an information display apparatus and a question input apparatus;

FIG. 3 is a block diagram of a detailed functional configuration example of a page managing unit;

FIG. 4 is a sequence diagram illustrating an example of a process for registering question information;

FIG. 5 is a diagram illustrating an image to be displayed for inputting items of weighting information;

FIG. 6 is a schematic diagram illustrating a data structure of the question information;

FIG. 7 is a schematic diagram illustrating a detailed example of the question information;

FIG. 8 is a sequence diagram of an example of a process for registering question-and-answer time information and rescheduling setting information;

FIG. 9 is a diagram illustrating an example of the rescheduling setting information;

FIG. 10 is a diagram illustrating an example of the rescheduling setting information;

FIG. 11 is a sequence diagram of a question-and-answer session starting process;

FIG. 12 is a schematic diagram illustrating an example of a schedule table;

FIG. 13 is a flowchart illustrating an example of a method for determining a display duration of each question;

FIG. 14 is a sequence diagram illustrating an example of the flow of rescheduling;

FIG. 15 is a flowchart illustrating an example of a rescheduling process;

FIG. 16 is a flowchart illustrating an example of an equal reduction process;

FIG. 17 is a diagram illustrating an example of execution of the equal reduction process;

FIG. 18 is a flowchart illustrating an example of a priority-based reduction process;

FIG. 19 is a diagram illustrating an example of execution of the priority-based reduction process;

FIG. 20 is a flowchart illustrating an example of a number-of-questions reduction process;

FIG. 21 is a diagram illustrating an example of execution of the number-of-questions reduction process;

FIG. 22 is a diagram illustrating a display example for notifying that rescheduling is completed;

FIG. 23 is a diagram illustrating a display example for notifying that a part of rescheduling has failed;

FIG. 24 is a diagram illustrating a display example for notifying that the entire rescheduling has failed;

FIG. 25 is a sequence diagram illustrating an example of the flow of rescheduling;

FIG. 26 is a schematic diagram for explaining the overview of a rescheduling process performed when equal reduction is selected;

FIG. 27 is a diagram illustrating an example of the rescheduling process performed when the equal reduction is selected;

FIG. 28 is a diagram for explaining the overview of the rescheduling process performed when priority-based reduction is selected;

FIG. 29 is a diagram illustrating an example of the rescheduling process performed when the priority-based reduction is selected;

FIG. 30 is a diagram for explaining the overview of the rescheduling process performed when reduction in the number of questions is selected;

FIG. 31 is a diagram illustrating an example of the rescheduling process performed when the reduction in the number of questions is selected;

FIG. 32 is a diagram illustrating a display example for notifying that additional information cannot be added to schedule because the priority of the additional information is lower than the priorities of remaining questions; and

FIG. 33 is a block diagram of a functional configuration example of an information display apparatus according to a modification.

### DETAILED DESCRIPTION OF THE PREFERRED EMBODIMENTS

Exemplary embodiments of the present invention will be explained in detail below with reference to the accompanying drawings.

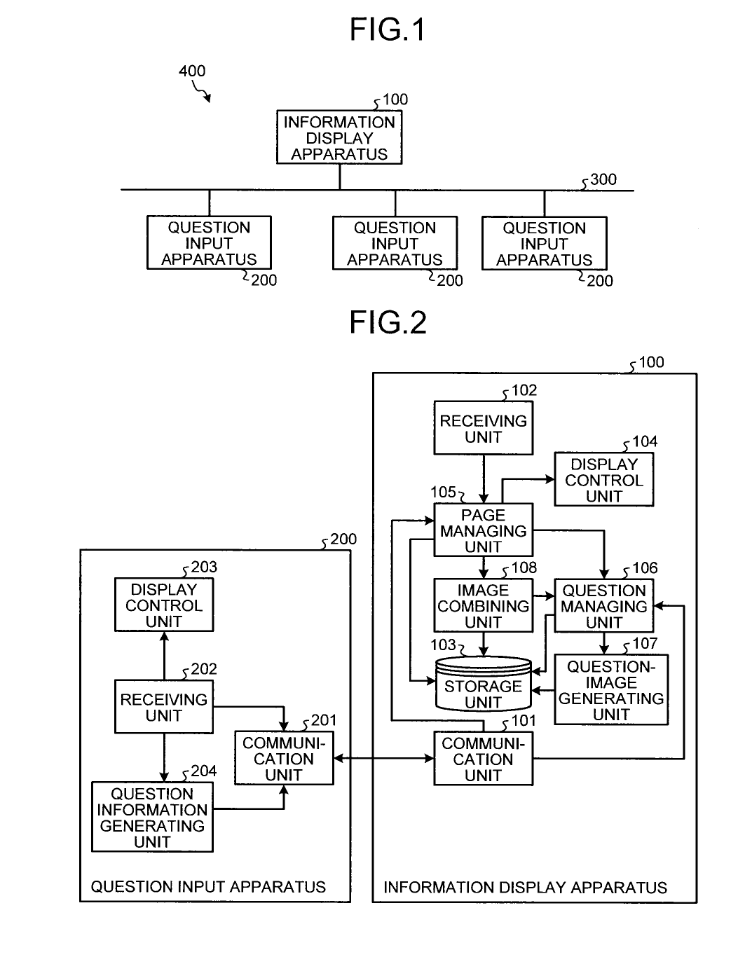

FIG. 1 is a block diagram of a schematic configuration of an information display system 400. FIG. 2 is a block diagram of a functional configuration example of an information display apparatus 100 and a question input apparatus 200. The information display system 400 according to an embodiment includes the information display apparatus 100 and a plurality of the question input apparatuses 200, such as personal computers (PCs), all of which are connected to a network 300, such as the Internet or a local area network (LAN).

In the present embodiment, the information display apparatus 100 includes a projector that projects or displays content of document data on a projection screen; however, it is not limited thereto.

The question input apparatus 200 will be explained in detail below. As illustrated in FIG. 2, the question input apparatus 200 mainly includes a communication unit 201, a receiving unit 202, a display control unit 203, and a question information generating unit 204.

The communication unit 201 transmits and receives various types of information and requests to and from the information display apparatus 100. For example, the communication unit 201 transmits question information (to be described later) to the information display apparatus 100.

The display control unit 203 displays a presentation image acquired from the information display apparatus 100 via the communication unit 201 on a display screen (not illustrated).

The receiving unit 202 receives various types of input. For example, the receiving unit 202 receives designations of a question display position and a questioned position in an image being displayed. The receiving unit 202 also receives text of the content of a question on an image being displayed. A user of the question input apparatus 200 can perform various input operations by operating an operating device, such as a mouse or a keyboard.

The question information generating unit 204 generates the question information based on information on the content of a question, information on the questioned position, and information on the question display position.

The information display apparatus 100 will be explained in detail below. As illustrated in FIG. 2, the information display apparatus 100 mainly includes a communication unit 101, a receiving unit 102, a storage unit 103, a display control unit 104, a page managing unit 105, a question managing unit 106, a question-image generating unit 107, and an image combining unit 108.

The communication unit 101 transmits and receives various types of information and requests to and from the question input apparatus 200. For example, the communication unit 101 receives the question information transmitted by the question input apparatus 200.

The display control unit 104 projects or displays various types of image data on a screen in a display format designated by a user.

The receiving unit 102 receives various types of input. For example, the receiving unit 102 receives an instruction to cause the display control unit 104 to suspend projection or display. The page managing unit 105 also receives an instruction to cause the display control unit 104 to resume projection or display after suspension of the projection or display. For example, a user can perform various input operations by operating an input device (an operating means) including a button, a remote-controlled receiving unit, or a card reader for reading information from an IC card or the like.

The storage unit 103 is a storage medium, such as a hard disk drive (HDD), and stores therein document data, a list of images, or the like, which will be explained later. The document data may be data generated by a presentation-material generating software or a word processor or may be presentation data converted from the generated data; however, it is not limited thereto.

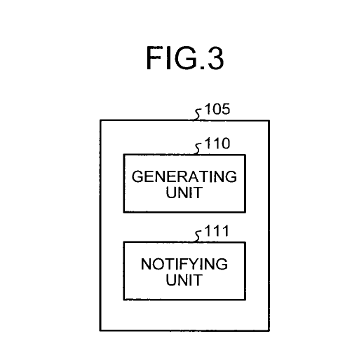

When the receiving unit 102 receives a question display request to display questions, the page managing unit 105 performs scheduling to determine the order of displaying the questions and display durations of the respective questions, and manages the degree to which the questions have actually been handled with respect to the generated schedule. When an actual question-and-answer session is behind or ahead of the generated schedule or an additional question is issued after the schedule is generated, the page managing unit 105 adjusts the generated schedule. FIG. 3 is a block diagram of a detailed functional configuration example of the page managing unit 105. As illustrated in FIG. 3, the page managing unit 105 includes a generating unit 110 and a notifying unit 111. The generating unit 110 generates a schedule table, in which the order of displaying questions received from the question input apparatus 200 and display durations of the respective questions are associated with each other. The notifying unit 111 issues a notice of a timing at which the display duration ends, based on the schedule table generated by the generating unit 110.

Referring back to FIG. 2, the explanation is continued. When receiving the question information from the question input apparatus 200, the question managing unit 106 adds a question ID or a questioner ID as identification management information to the question information.

The image combining unit 108 issues a question-image generation request to the question managing unit 106 based on the question information designated by the page managing unit 105 and generates a combination image, in which a question and a slide are combined.

The question-image generating unit 107 determines the size of a question image based on the information on the question display position and the information on the questioned position and draws the content of the question and the name of a questioner.

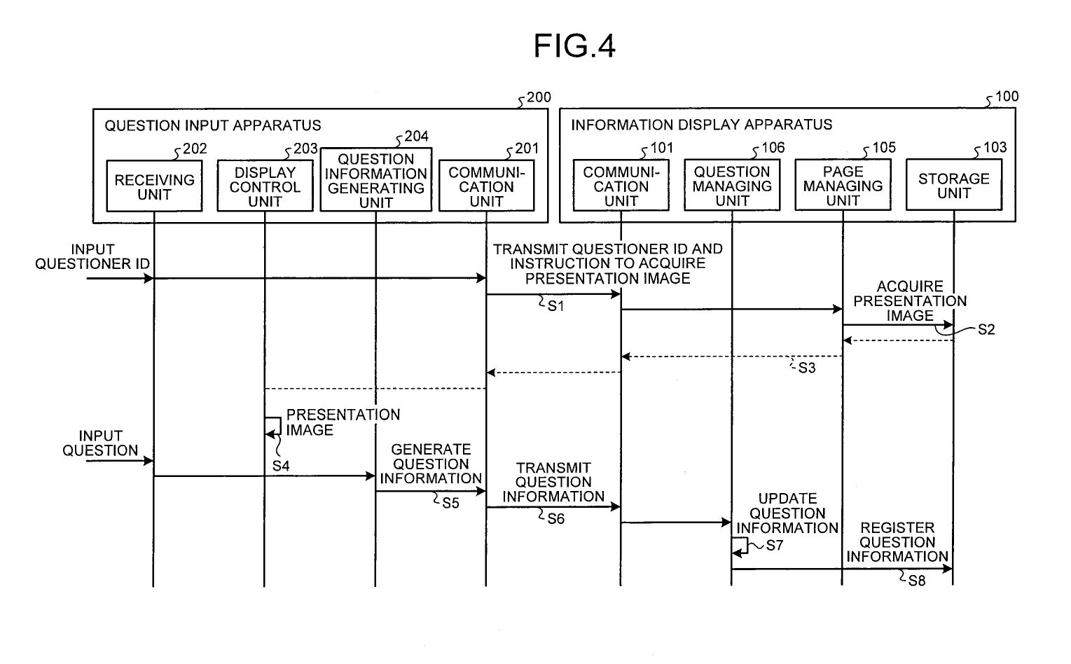

A process for registering the question information by the information display system 400 configured as above according to the present embodiment will be explained below. FIG. 4 is a sequence diagram of the process for registering the question information.

A user inputs a questioner ID to the question input apparatus 200 when accessing the system. When receiving the questioner ID, the question input apparatus 200 transmits the received questioner ID and an instruction to acquire a presentation image to the information display apparatus 100 via the communication unit 201 (Step S1).

When the communication unit 101 of the information display apparatus 100 receives the instruction to acquire the presentation image, the page managing unit 105 acquires the presentation image (an image to be displayed) from the storage unit 103 (Step S2).

The information display apparatus 100 transmits the acquired presentation image (the image to be displayed) to the question input apparatus 200 via the communication unit 101 (Step S3).

When the communication unit 201 of the question input apparatus 200 receives the presentation image, the display control unit 203 displays the received presentation image (Step S4). In the present embodiment, the same image as the image that is projected or displayed on the screen by the information display apparatus 100 is displayed on the display screen of the question input apparatus 200.

During the presentation where various pieces of image data are sequentially projected or displayed on the screen, the user (the questioner) of the question input apparatus 200 can input a question on the presentation image (the same image as the image projected on the screen) displayed on the question input apparatus 200 by operating the operating device (not illustrated). When the receiving unit 202 receives the question on the presentation image, the question information generating unit 204 generates question information based on the received question (Step S5).

The questioner designates a questioned position, a question display position, and a questioned page with respect to a presentation image being displayed on the display screen of the question input apparatus 200, and also inputs the content of a question.

When the receiving unit 202 receives the content of the question and the like as described above, the question information generating unit 204 generates the question information based on information on the content of the question, information on the questioned position, information on the question display position, and information on the questioned page, which are received by the receiving unit 202.

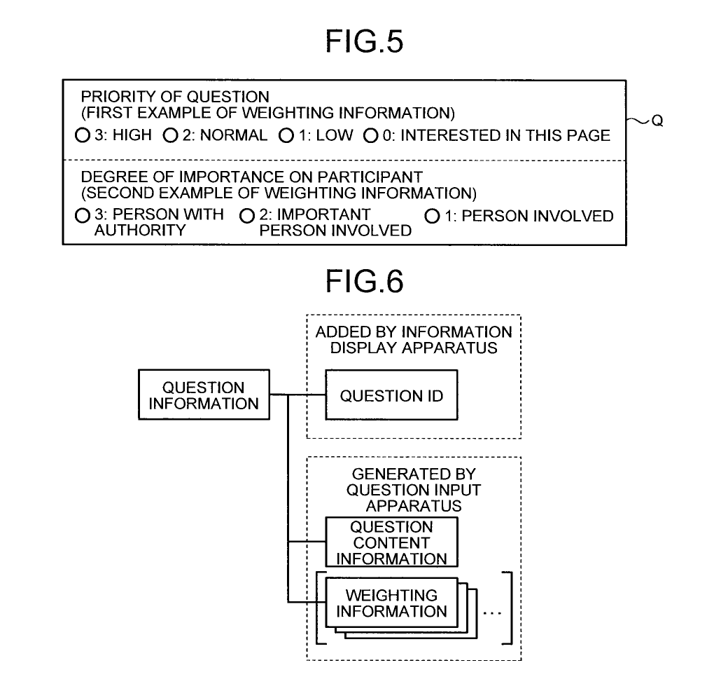

The question information generating unit 204 acquires a presentation image Q as illustrated in FIG. 5 from the storage unit 103 of the information display apparatus 100 and displays the presentation image Q on the display screen so as to allow the questioner to manually input question weighting information (for example, the priority of a question or the degree of importance on a participant). In this manner, the questioner can freely add weights to the questions according to the contents of the presentation or the importance of the question.

It may be possible to store user information on the questioner in the question managing unit 106 of the information display apparatus 100 and automatically input a selected item of the weighting information based on the questioner ID. If the user information is stored and the selected item of the weighting information is also stored in association with the questioner when the questioner registers the question information, it becomes possible for the system to automatically associate an item that is fixed as the user information without manually inputting the item. The weighting information (for example, the priority of a question) is used as information on the weight added to a question when the scheduling is performed; details thereof will be explained later.

After the process at Step S5, the question input apparatus 200 transmits the generated question information to the information display apparatus 100 via the communication unit 201 (Step S6).

When the communication unit 101 receives the question information from the question input apparatus 200, the question managing unit 106 updates the received question information by adding a question ID for identifying the question information to the received question information (Step S7).

The information display apparatus 100 registers the question information in the storage unit 103 (Step S8).

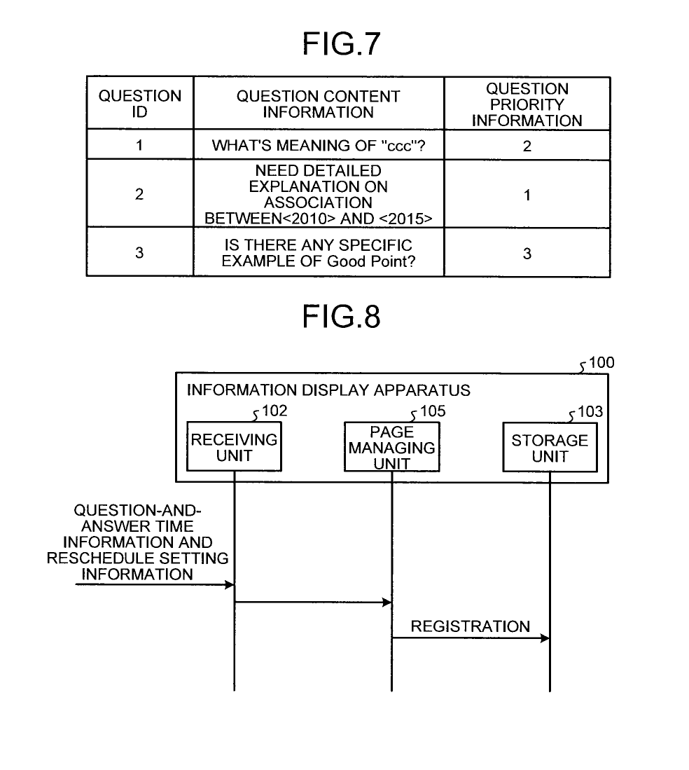

FIG. 6 is a schematic diagram illustrating an example of the data structure of the question information. FIG. 7 is a schematic diagram illustrating a detailed example of the question information. As illustrated in FIGS. 6 and 7, the question information contains a question ID, question content information, question priority information (weighting information), and the like. The question content information and the priority information are generated by the question input apparatus 200. The priority information is designated in the descending order (3, 2, 1, and 0) according to the priority. The question ID is added by the information display apparatus 100. In the present embodiment, the number indicating the order of receiving the question is added as the question ID to the question information.

Described below is a process for registering question-and-answer time information as information on a duration of a question-and-answer session and for registering rescheduling setting information on the setting of rescheduling, which will be described later. FIG. 8 is a sequence diagram of the process for registering the question-and-answer time information and the rescheduling setting information.

A user (a presenter) of the information display apparatus 100 inputs the question-and-answer time information and the rescheduling setting information by operating an operating device (for example, a button, a keyboard, or a mouse) included in the information display apparatus 100. When the receiving unit 102 receives the question-and-answer time information and the rescheduling setting information, the page managing unit 105 registers the received question-and-answer time information and the received rescheduling setting information in the storage unit 103.

The question-and-answer time information contains a question-and-answer time indicating the total duration (for example, total minutes) of a question-and-answer session (the overall time taken to the question-and-answer session) and contains a minimum question time to be set as the minimum duration of handling one question.

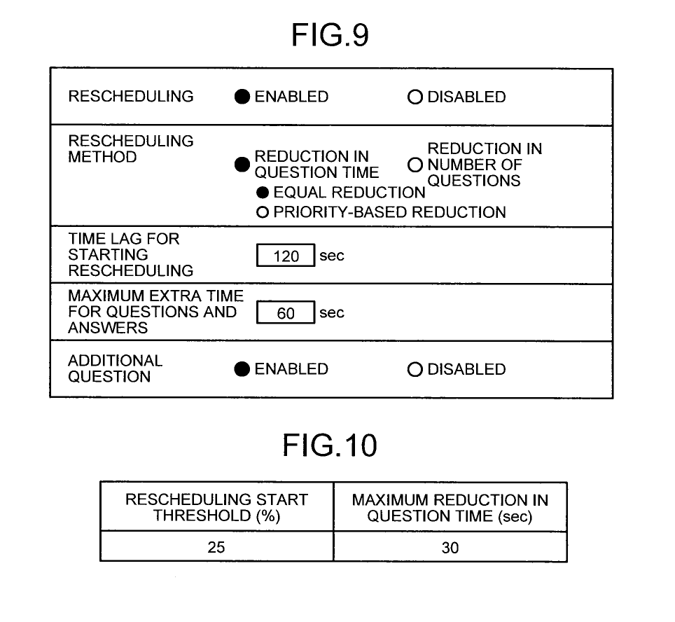

FIGS. 9 and 10 are diagrams illustrating examples of the rescheduling setting information. In FIG. 9, “rescheduling” is an item for setting whether or not to perform rescheduling; when “enabled” is selected and if a predetermined condition is satisfied, the schedule table is adjusted (the rescheduling is performed). “Rescheduling method” is an item for setting the way to perform rescheduling; a user is allowed to select either “Reduction in question time”, which is a method to reduce a display duration of a question, or “Reduction in the number of questions”, which is a method to reduce the number of questions. When the “Reduction in question time” is selected, the user is allowed to select either “Equal reduction”, which is a method to equally reduce the display durations of remaining questions (unhandled questions), or “Priority-based reduction”, which is a method to reduce the display durations of the remaining questions by different lengths of time in accordance with the priorities of the respective questions.

“Time lag for starting rescheduling” is an item for setting after how much time lag from the generated schedule the rescheduling is started. For example, if the time lag for starting rescheduling is set to “120 seconds” and when a time lag between the display duration shown in the generated schedule table and the actual display duration exceeds 120 seconds, the rescheduling is performed. “Maximum extra time for questions and answers” is an item for setting the length of time (a maximum extra time) after which the display of a question is forcibly terminated if a scheduled question end time has already passed when the reschedule start time comes. “Additional question” is an item for setting whether or not to accept additional questions after the schedule table is generated. When “enabled” is selected in the item “Additional question”, it is allowed to issue an additional question after the schedule table is generated (after the question-and-answer session has started).

In FIG. 10, “Rescheduling start threshold” is an item for determining a timing at which the rescheduling is started. “Maximum reduction in question time” is an item for setting the maximum length of time by which the display duration of each of the remaining questions is reduced when the rescheduling is performed.

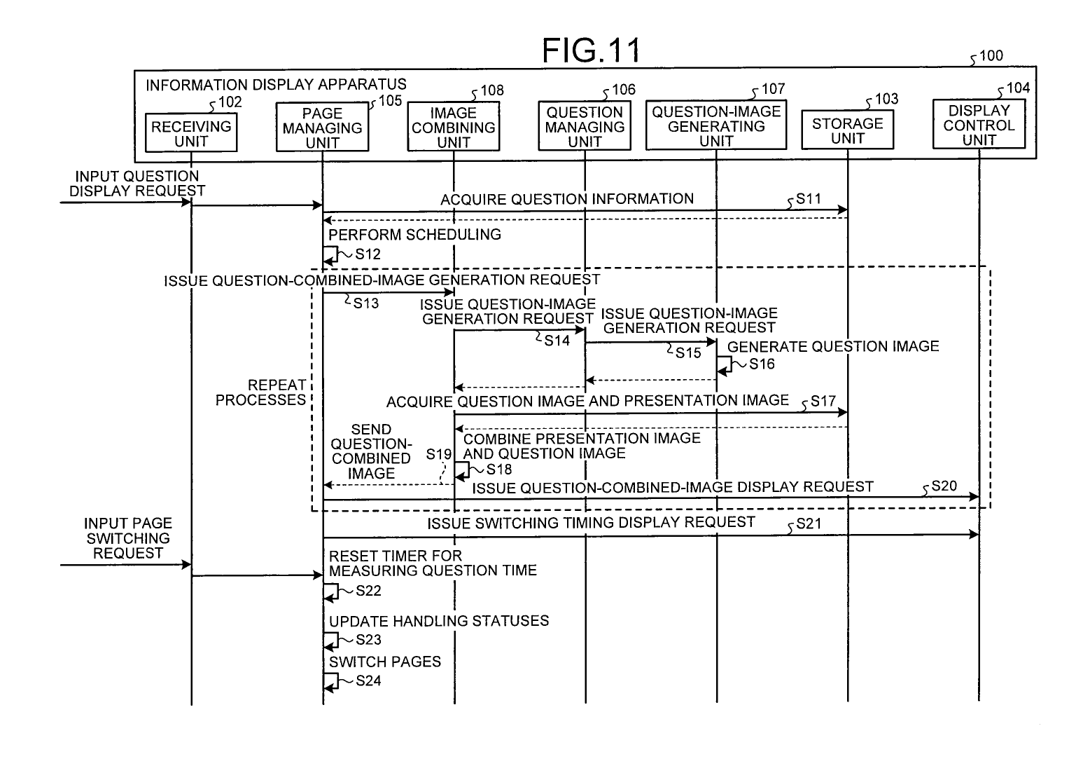

A question-and-answer session starting process performed by the information display apparatus 100 will be explained below. FIG. 11 is a sequence diagram of the question-and-answer session starting process.

When a question-and-answer session starts after the completion of the presentation, the user (the presenter) of the information display apparatus 100 inputs a question display request to display questions received during the presentation, by operating the operating device (not illustrated). When the receiving unit 102 receives the question display request, the page managing unit 105 acquires a plurality of pieces of the question information stored in the storage unit 103 (Step S11). The page managing unit 105 (the generating unit 110) generates a schedule table, in which the order of displaying the questions and the display durations of the respective questions are associated with each other so that the total display duration of all the questions can be within the question-and-answer time set in advance (Step S12).

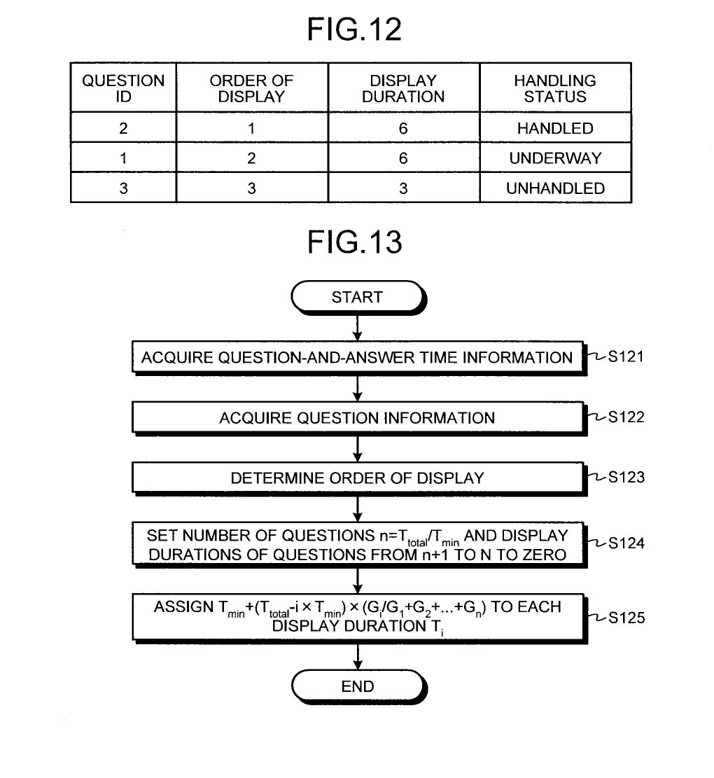

FIG. 12 is a schematic diagram illustrating an example of the schedule table. In the example in FIG. 12, the order of displaying a question, the display duration of the question, and a handling status of the question are associated with one another for each question (for each question ID). In the example in FIG. 12, the handling status of a question that has been handled in the question-and-answer session (a question that is no longer displayed) becomes “handled”; the handling status of a question that is being handled (a question being displayed) becomes “underway”; and the handling status of a question that has not been handled yet (a question that is not displayed yet) becomes “unhandled”.

FIG. 13 is a flowchart illustrating an example of a method for determining the display duration of each question. As illustrated in FIG. 13, the page managing unit 105 acquires the question-and-answer time information from the storage unit 103 (Step S121). The page managing unit 105 acquires the question information from the storage unit 103 (Step S122). The page managing unit 105 determines the order of displaying questions based on the priority information contained in the question information acquired at Step S122 (Step S123). In the present embodiment, the page managing unit 105 determines the order of displaying the questions such that a question having a higher priority is displayed earlier. For example, in the example in FIG. 7, the questions are displayed in order of a question ID 2, a question ID 1, and then a question ID 3.

The page managing unit 105 sets the number of questions n to be handled such that (a total question-and-answer time Tₜₒₜₐₗ) /(a minimum question time Tₘᵢₙ) and sets the question time of each of N registered questions counted from the n+1 question to zero (Step S124).

The page managing unit 105 assigns a display duration Tᵢ to each of the questions based on weighting information Gᵢ (Step S125). The display duration Tᵢ is represented by Equation below.

Tᵢ=Tₘᵢₙ+(Tₜₒₜₐₗ−i×Tᵣₐᵢₙ)×(Gᵢ/G₁+G₂+ . . . +Gₙ)

In this manner, by causing the question having a higher priority to be displayed earlier and for a longer display duration, it becomes possible to improve the effectiveness of the question-and-answer session.

Referring back to FIG. 11, the explanation is continued. After the schedule table is generated (after the scheduling is performed), the page managing unit 105 issues a question-combined-image generation request to the image combining unit 108 in accordance with the order of display shown in the schedule table (Step S13).

The image combining unit 108 issues a question-image generation request to the question managing unit 106 (Step S14). The question managing unit 106 issues the question-image generation request to the question-image generating unit 107 (Step S15).

The question-image generating unit 107 generates a question image based on the question information (Step S16). The question image generated by the question-image generating unit 107 is stored in the storage unit 103.

The image combining unit 108 acquires the question image of a question to be displayed and a presentation image from the storage unit 103 (Step S17), and generates a question-combined image by combining the presentation image and the question image (Step S18). The image combining unit 108 sends the question-combined image to the page managing unit 105 (Step S19). The page managing unit 105 requests the display control unit 104 to display the acquired question-combined image (Step S20).

The page managing unit 105 issues a notice of a timing (a time) at which the display duration of the question set in the schedule table ends after the display of the question-combined image is started. Specifically, the page managing unit 105 measures a time by a timer after the display of the question-combined image is started and requests the display control unit 104 to display a switching timing indicating a timing (a time) at which the display duration of the question set in the schedule table ends (Step S121). The way to issue the notice is arbitrary. For example, the page managing unit 105 may use voice to issue the notice of a timing at which the display duration set in the schedule table ends.

Thereafter, the user (the presenter) of the information display apparatus 100 inputs a switching request to switch between questions in order to handle a next question, by operating the operating device (not illustrated). When the receiving unit 102 receives the input switching request, the page managing unit 105 resets the timer that measures the question time (Step S22), updates the handling statuses in the schedule table (Step S23), and switches between pages (Step S24). Then, the processes at Step S13 to Step S20 are repeated to display a question-combined image of the next question.

Rescheduling performed by the information display apparatus 100 will be explained below. When a predetermined condition is satisfied after the schedule table is generated, the information display apparatus 100 adjusts the schedule table so that questions can be displayed within the question-and-answer time that is set in advance (performs the rescheduling). The predetermined condition in the present embodiment is that a difference between the display duration shown in the schedule table and the actual display duration exceeds a threshold or that new question information is received from the question input apparatus 200 after the schedule table is generated.

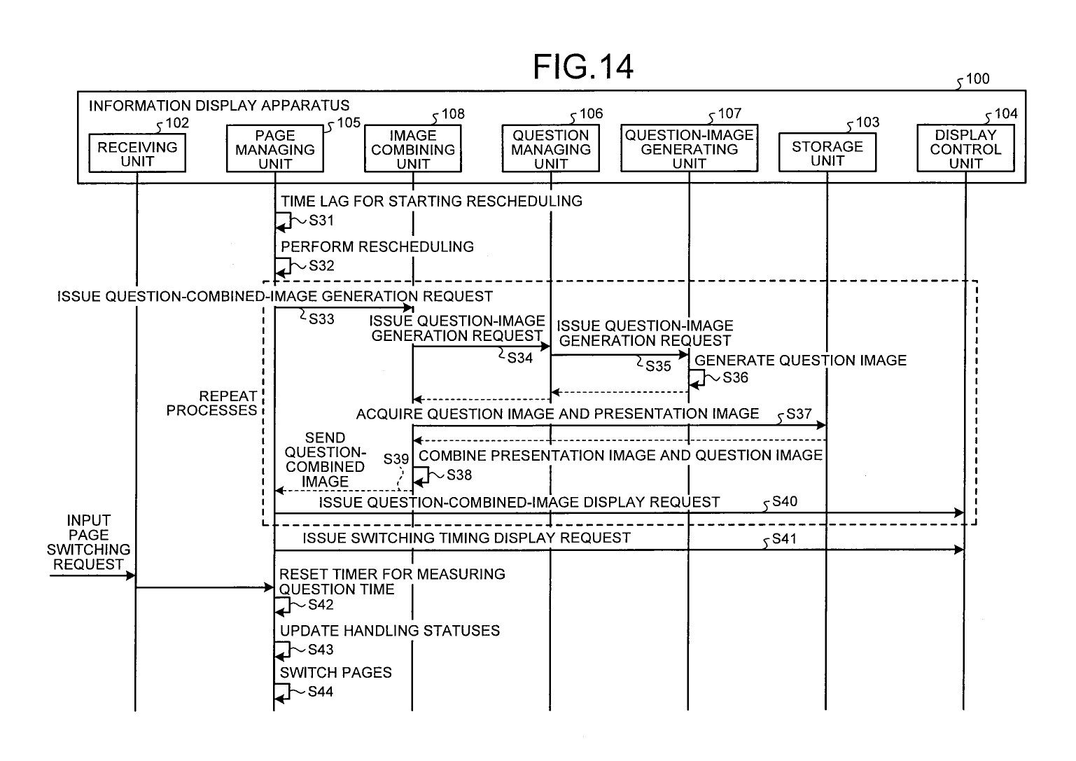

An explanation is given of the rescheduling in the case that a difference between the display duration shown in the schedule table and the actual display duration exceeds the threshold after the schedule table is generated. FIG. 14 is a sequence diagram illustrating the flow of the rescheduling that is performed when a difference between the display duration shown in the schedule table and the actual display duration exceeds the threshold. The page managing unit 105 determines whether a difference between the display duration shown in the generated schedule table and the actual display duration exceeds the time lag for starting rescheduling that is set in advance (see FIG. 9) (Step S31). When determining that the difference exceeds the time lag for starting rescheduling, the page managing unit 105 performs the rescheduling (Step S32). The processes from Step S33 to Step S44 are the same as those at Step S13 to Step S24 in FIG. 11; therefore, the detailed explanation is not repeated.

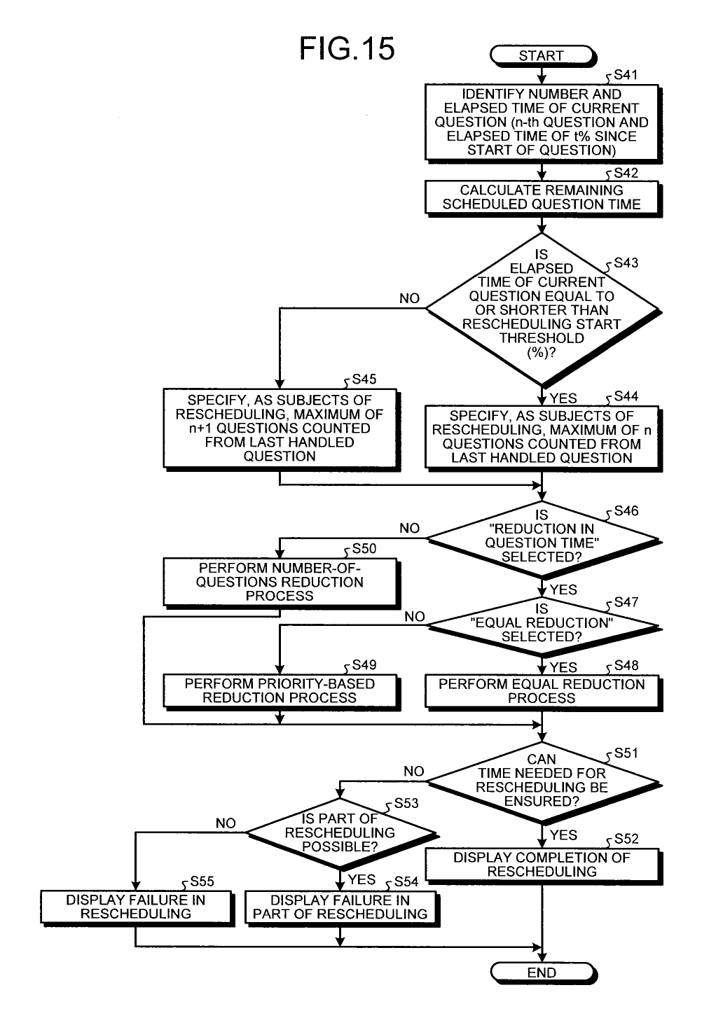

FIG. 15 is a flowchart illustrating an example of a rescheduling process. The page managing unit 105 identifies a question having the handling status of “underway” (a current question) and identifies a time elapsed since the start of display of the question (an elapsed time) (Step S41). The page managing unit 105 calculates a remaining scheduled question time (Step S42). For example, if the current time has already passed a scheduled question end time of the current question, it is determined that the handling of the current question ends at a time after the maximum extra time (see FIG. 9) set in advance elapses from the current time. In this case, the page managing unit 105 calculates the remaining question-and-answer time by adding the maximum extra time to the display durations of remaining questions (unhandled questions).

The page managing unit 105 determines whether the elapsed time of the current question is equal to or shorter than the rescheduling start threshold that is set in advance (Step S43). When the determination at Step S43 is affirmative (YES at Step S43), the page managing unit 105 specifies a maximum of n questions counted from the question that has last been handled, as the subjects of the rescheduling process (Step S44). On the other hand, when the determination at Step S43 is negative (NO at Step S43), the page managing unit 105 specifies a maximum of n+1 questions counted from the question that has last been handled, as the subjects of the rescheduling process (Step S45).

The page managing unit 105 determines whether “Reduction in question time” (see FIG. 9) is selected as the rescheduling method (Step S46). When the determination at Step S46 is affirmative (YES at Step S46), the page managing unit 105 determines whether “Equal reduction” (see FIG. 9) is selected as the rescheduling method (Step S47). When the determination at Step S47 is affirmative (YES at Step S47), the page managing unit 105 performs an equal reduction process (Step S48).

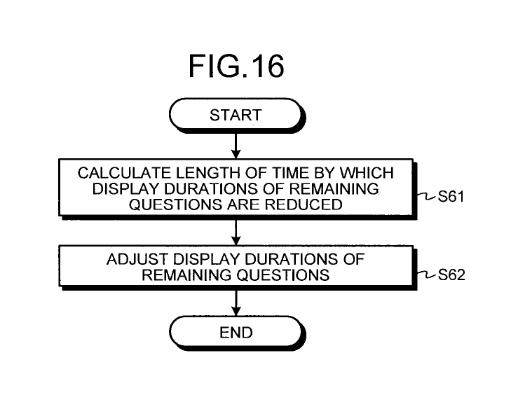

FIG. 16 is a flowchart illustrating an example of the equal reduction process. The page managing unit 105 calculates the length of time by which each of the display durations of the remaining questions (the unhandled questions) shown in the schedule table is reduced (a reduction time) (Step S61). Specifically, the page managing unit 105 calculates a difference between the remaining question-and-answer time calculated at Step S42 and a scheduled question-and-answer end time that is set in advance, thereby obtaining a total reduction time. Subsequently, the page managing unit 105 divides the calculated total reduction time by the number of the remaining questions (the number of questions to be subjected to the rescheduling process), thereby obtaining the reduction time. The page managing unit 105 then adjusts the display durations of the remaining questions (Step S62). Specifically, the page managing unit 105 reduces the display duration of each of the remaining questions by the reduction time calculated at Step S61. Accordingly, the schedule table is adjusted.

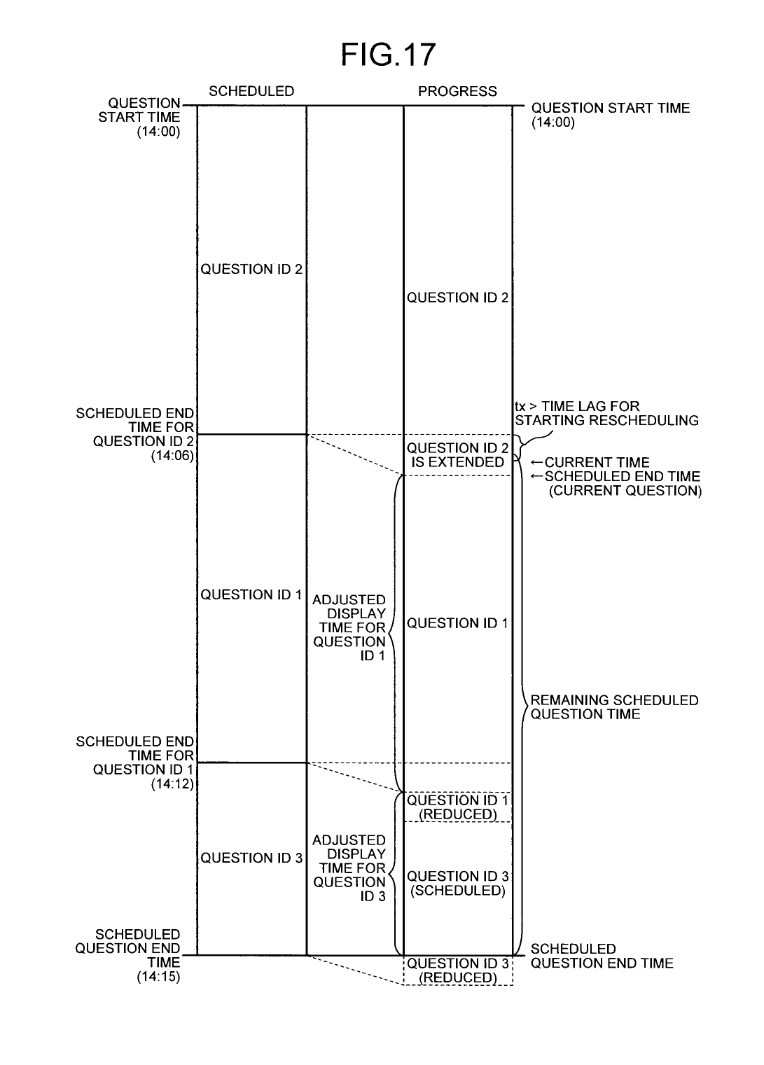

FIG. 17 is a diagram illustrating an example in which the equal reduction process is performed after the schedule table illustrated in FIG. 12 is generated. In the example in FIG. 17, a question with the question ID 2 is still handled at the current time (display of the question ID 2 is continued), and a difference tx between the scheduled time at which the display of the question ID 2 ends and the current time (a difference between the display duration shown in the schedule table and the actual display duration) exceeds the time lag for starting rescheduling that is set in advance. Therefore, the rescheduling is performed at the current time. In the example in FIG. 17, questions with the question IDs 1 and 3 are the subjects of the rescheduling process, and the reduction time is commonly set for the question IDs 1 and 3 so that these questions can be displayed within the question-and-answer time set in advance. In the example in FIG. 17, because the current time has already passed the scheduled question end time set for the question ID 2, the handling of the question ID 2 ends at a time after the maximum extra time (see FIG. 9) set in advance elapses from the current time. Therefore, the page managing unit 105 sets a common reduction time for each of the question IDs 1 and 3 such that the sum of the duration of handling of the question ID 2, an adjusted (rescheduled) duration of display of the question ID 1, and an adjusted (rescheduled) duration of display of the question ID 3 becomes equal to the question-and-answer time set in advance.

Referring back to FIG. 15, the explanation is continued. When the determination at Step S47 is negative (NO at Step S47), the page managing unit 105 determines that “priority-based reduction” is selected as the rescheduling method and performs a priority-based reduction process (Step S49).

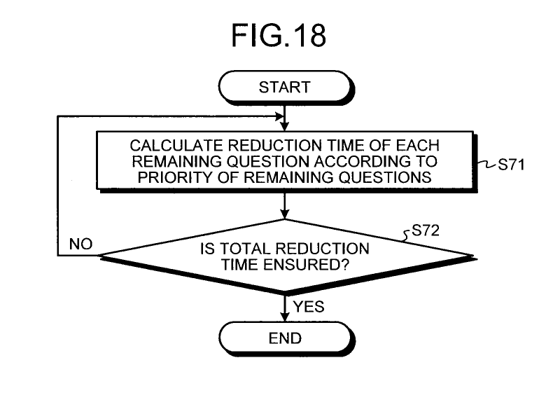

FIG. 18 is a flowchart illustrating an example of the priority-based reduction process. The page managing unit 105 calculates a reduction time of each of the remaining questions (the unhandled questions) in the schedule table in accordance with the priorities of the remaining questions (Step S71). Specifically, the page managing unit 105 sets a reduction time of each of the remaining questions (see FIG. 10) such that the reduction time is within the maximum reduction time set in advance and a longer reduction time is set for a question having a lower priority according to the priorities of the remaining questions. The page managing unit 105 determines whether the sum of the reduction times of the remaining questions reaches the total reduction time described above (whether the total reduction time is ensured) (Step S72). When it is determined that the total reduction time is ensured (YES at Step S72), the process ends. On the other hand, when it is determined that the total reduction time is not ensured (NO at Step S72), the process returns to Step S71 and the reduction time of each of the remaining questions is calculated again.

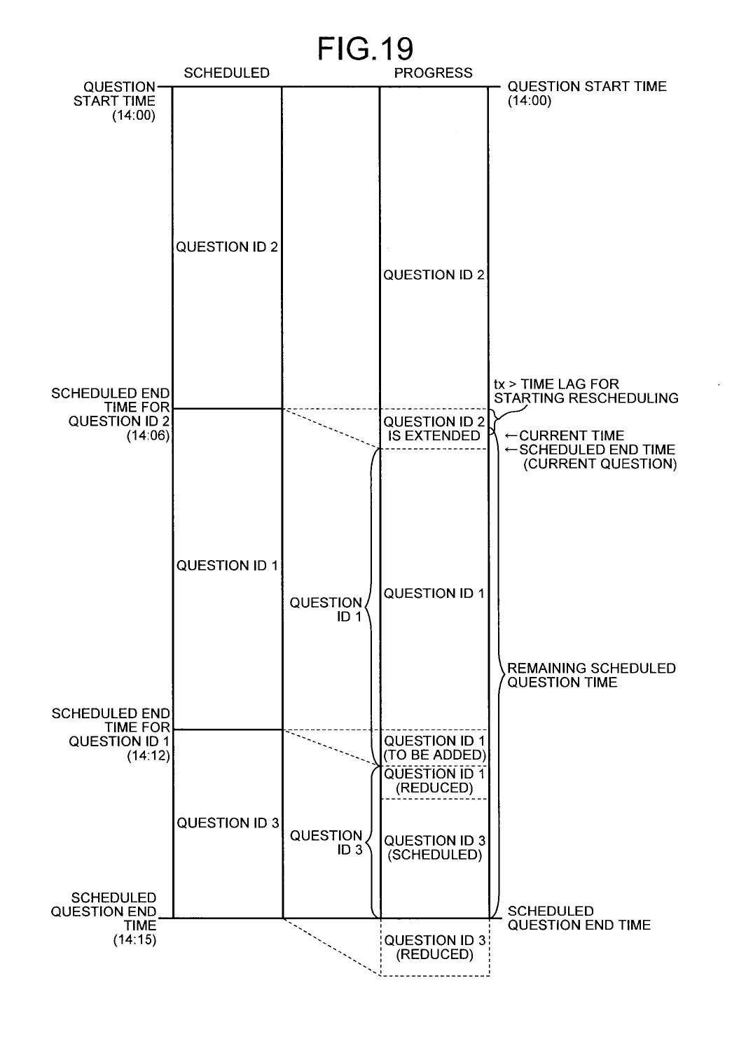

FIG. 19 is a diagram illustrating an example in which the priority-based reduction process is performed after the schedule table illustrated in FIG. 12 is generated. In the example in FIG. 19, the question with the question ID 2 is still handled at the current time (display of the question ID 2 is continued), and a difference tx between the scheduled time at which the display of the question ID 2 ends and the current time (a time point) (a difference between the display duration shown in the schedule table and the actual display duration) exceeds the time lag for starting rescheduling that is set in advance. Therefore, the rescheduling is performed at the current time. In the example in FIG. 19, the questions with the question IDs 1 and 3 are the subjects of the rescheduling process, and the reduction time of each of the question IDs 1 and 3 is set according to the priorities of the questions so that the questions can be displayed within the question-and-answer time set in advance. In this case, the page managing unit 105 sets the reduction time for each of the question IDs 1 and 3 so that the sum of the duration from the question start time to the question end time of the question ID 2, an adjusted (rescheduled) duration of display of the question ID 1, and an adjusted (rescheduled) duration of display of the question ID 3 becomes equal to the question-and-answer time set in advance. As illustrated in FIG. 12, because the priority of the question ID 1 is higher than the priority of the question ID 3, the reduction time of the question ID 1 is set to be shorter than the reduction time of the question ID 3.

Referring back to FIG. 15, the explanation is continued. When the determination at Step S46 is negative (NO at Step S46), the page managing unit 105 determines that “reduction in the number of questions” is selected as the rescheduling method and performs a number-of-questions reduction process (Step S50).

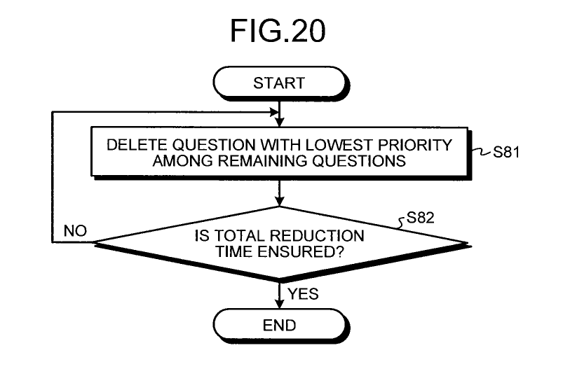

FIG. 20 is a flowchart illustrating an example of the number-of-questions reduction process. The page managing unit 105 deletes a question having the lowest priority among the remaining questions (the unhandled questions) in the schedule table (Step S81). Subsequently, the page managing unit 105 determines whether the display duration of the deleted question is equal to or longer than the total reduction time (whether the total reduction time is ensured) (Step S82). When it is determined that the total reduction time is ensured (YES at Step S82), the process ends. On the other hand, when it is determined that the total reduction time is not ensured (NO at Step S82), the process returns to Step S81, at which a question having the lowest priority is deleted from among the remaining questions (the questions except for the question that has been deleted in the previous process), and then the determination at Step S82 is performed again.

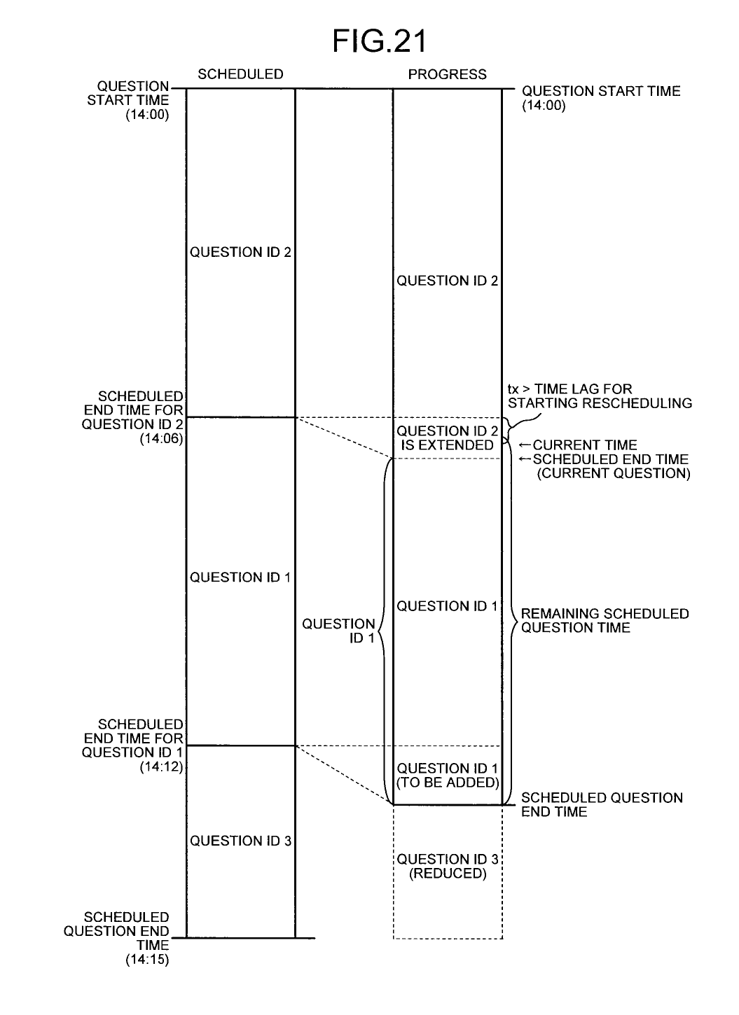

FIG. 21 is a diagram illustrating an example in which the number-of-questions reduction process is performed after the schedule table illustrated in FIG. 12 is generated. In the example in FIG. 21, the question with the question ID 2 is still handled at the current time (display of the question ID 2 is continued), and a difference tx between the scheduled end time of the display duration of the question ID 2 shown in the schedule table and the current time (a time point) (a difference between the display duration shown in the schedule table and the actual display duration) exceeds the time lag for starting rescheduling set in advance. Therefore, the rescheduling is performed at the current time. In the example in FIG. 21, the questions with the question IDs 1 and 3 are the subjects of the rescheduling and the priority of the question ID 3 is lower than the priority of the question ID 1 as indicated in FIG. 12; therefore, the question ID 3 is deleted from the schedule table. In this example, the display duration of the question ID 3 is longer than the total reduction time; therefore, it becomes possible to complete the display of the questions within the question-and-answer time set in advance by deleting only the question ID 3. Accordingly, the page managing unit 105 deletes the question having the lowest priority among the remaining questions from the schedule table in order to complete the display of the questions within the question-and-answer time set in advance.

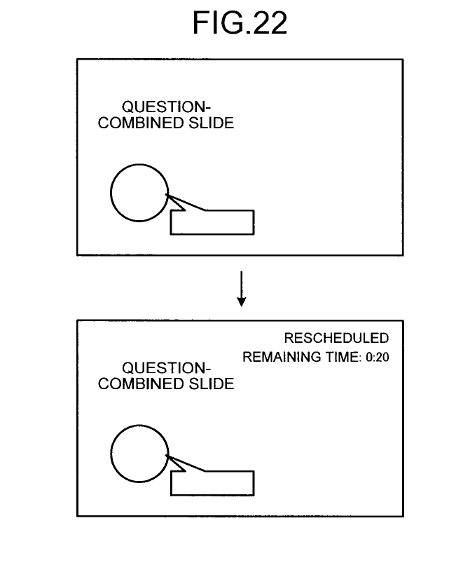

Referring back to FIG. 15, the explanation is continued. After the process at Step S48, Step S49, or Step S50 is finished, the page managing unit 105 determines whether a time needed for the rescheduling can be ensured (whether all the remaining questions can be displayed) (Step S51). When it is determined that the time needed for the rescheduling can be ensured (YES at Step S51), the page managing unit 105 causes the display control unit 104 to display a notice of completion of the rescheduling (Step S52). FIG. 22 is a diagram illustrating a display example for notifying that the rescheduling is completed. In the example in FIG. 22, a rescheduled duration (an adjusted display duration) is also displayed.

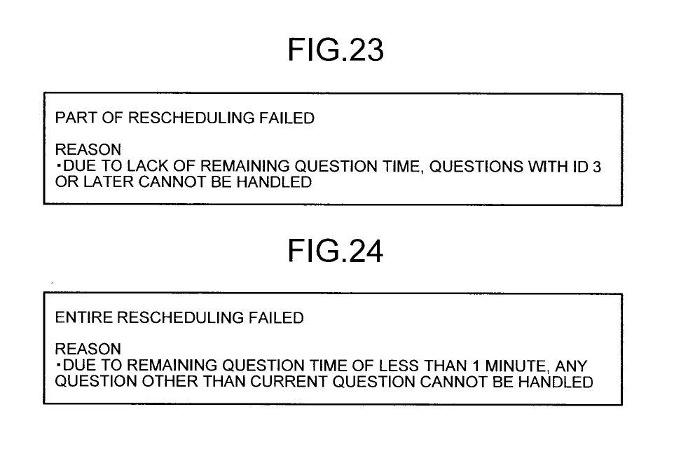

On the other hand, when it is determined that the time needed for the rescheduling is not ensured at Step S51 (NO at Step S51), the page managing unit 105 determines whether a part of the rescheduling is possible (whether a part of questions is displayable) (Step S53). When it is determined that a part of the rescheduling is possible (YES at Step S53), the page managing unit 105 causes the display control unit 104 to display a notice indicating that a part of the rescheduling has failed (Step S54). FIG. 23 is a diagram illustrating a display example for notifying that a part of rescheduling has failed. In the example in FIG. 23, a notice is displayed indicating that a part of questions (the question ID 3 in this example) is not displayable (cannot be handled) because of lack of the remaining question time (the duration from the end of the current question ID 2 to the end of the question-and-answer time set in advance).

When it is determined that even a part of the rescheduling is not possible (NO at Step S53), the page managing unit 105 causes the display control unit 104 to display a notice indicting that the entire rescheduling has failed (Step S55). FIG. 24 is a diagram illustrating a display example for notifying that the entire rescheduling has failed. In the example in FIG. 24, a notice is displayed indicating that questions other than the current question are not displayable (cannot be handled) due to the lack of the remaining question time.

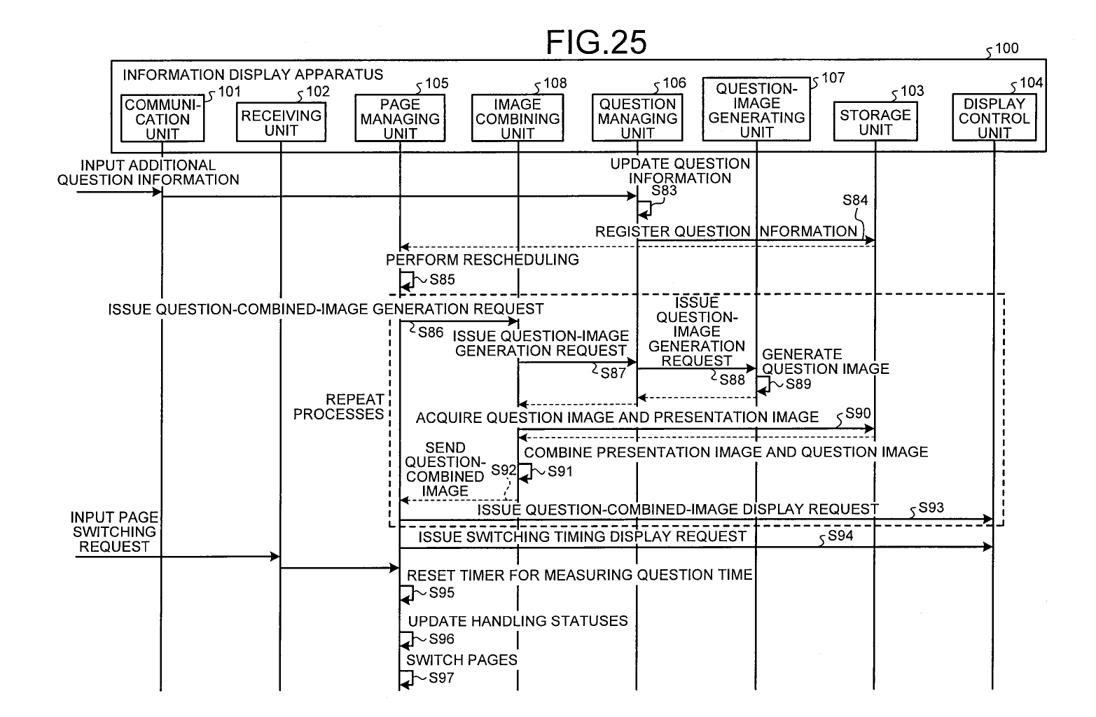

An explanation will be given of the rescheduling that is performed when new question information is received from the question input apparatus 200 after the schedule table is generated. FIG. 25 is a sequence diagram of the flow of the rescheduling performed when new question information is received from the question input apparatus 200. When the communication unit 101 of the information display apparatus 100 receives additional question information from the question input apparatus 200, the question managing unit 106 updates the received question information by adding the question ID to the received question information (Step S83). The question managing unit 106 registers the updated question information in the storage unit 103 (Step S84). The page managing unit 105 acquires a plurality of pieces of the question information stored in the storage unit 103 and performs rescheduling (Step S85). The processes from Step S86 to Step S97 are the same as those at Step S13 to Step 5124 in FIG. 11; therefore, the detailed explanation is not repeated.

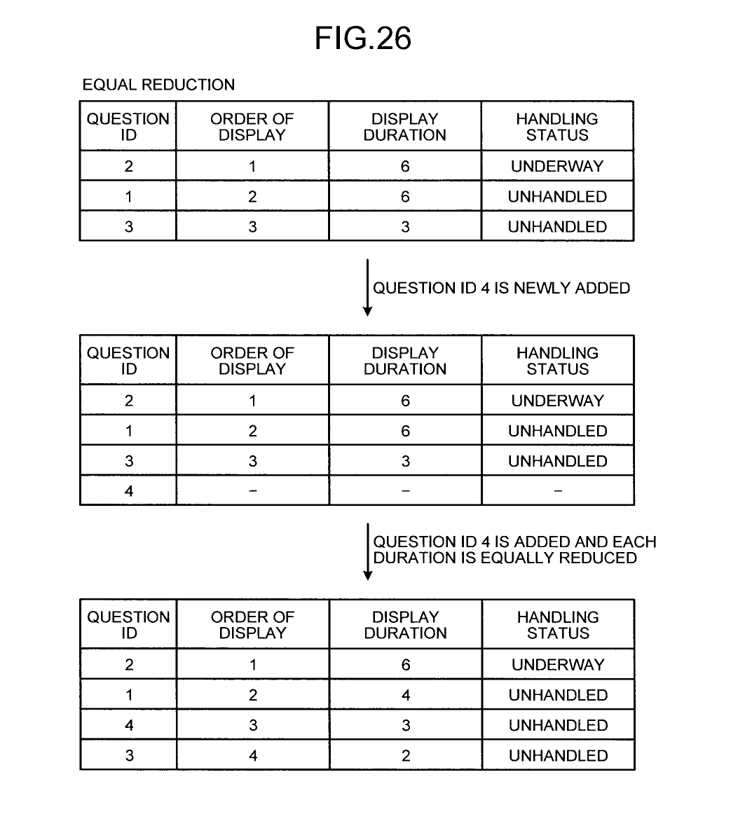

FIG. 26 is a schematic diagram for explaining the overview of the rescheduling process performed when “Equal reduction” is selected. In the example in FIG. 26, it is assumed that a question with a question ID 4 is added. The page managing unit 105 determines the order of display by referring to the priority information (the weighting information) contained in the question information of each of the question IDs 1 to 4 and also determines the display duration of the question ID 4. The display duration of the question ID 4 is determined by, for example, the method explained with reference to FIG. 13. The page managing unit 105 performs the equal reduction process illustrated in FIG. 20 to calculate a common reduction time for the unhandled questions (in this example, the questions with the question IDs 1, 3, and 4). The page managing unit 105 then reduces the display durations of each of the unhandled questions by the reduction time to adjust the schedule table.

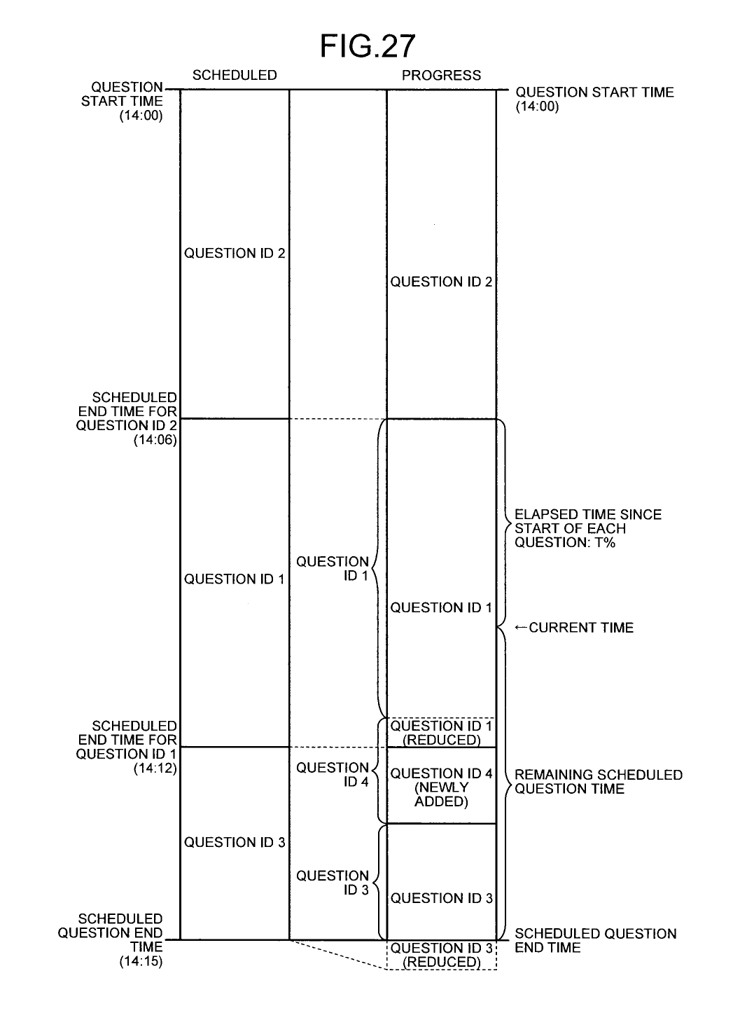

FIG. 27 is a diagram illustrating an example of the rescheduling process performed when “Equal reduction” is selected (in connection with FIG. 26). In the example in FIG. 27, the elapsed time of the current question ID 1 is shorter than the rescheduling start threshold set in advance; therefore, the questions with the question IDs 1, 4, and 3 become the subjects of the rescheduling. The page managing unit 105 sets a common reduction time for the questions with the question IDs 1, 4, and 3 so that the questions can be displayed within the question-and-answer time set in advance.

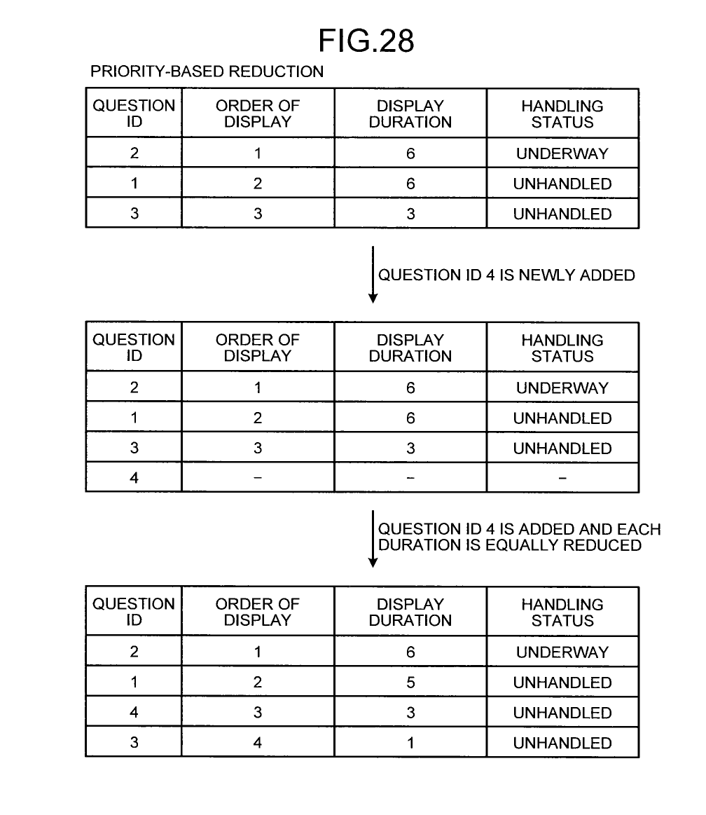

FIG. 28 is a diagram for explaining the overview of the rescheduling process performed when “Priority-based reduction” is selected. In the example in FIG. 28, it is assumed that the question with the question ID 4 is added. The page managing unit 105 determines the order of display by referring to the priority information (the weighting information) contained in the question information of each of the question IDs 1 to 4 and also determines the display duration of the question ID 4. The display duration of the question ID 4 is determined by, for example, the method explained with reference to FIG. 13. The page managing unit 105 performs the priority-based reduction process shown in FIG. 18 to calculate the reduction time of each of the unhandled questions (in this example, the questions with the question IDs 1, 3, and 4) in accordance with the priorities of the respective questions. The page managing unit 105 reduces the display duration of each of the unhandled questions by the reduction time to adjust the schedule table.

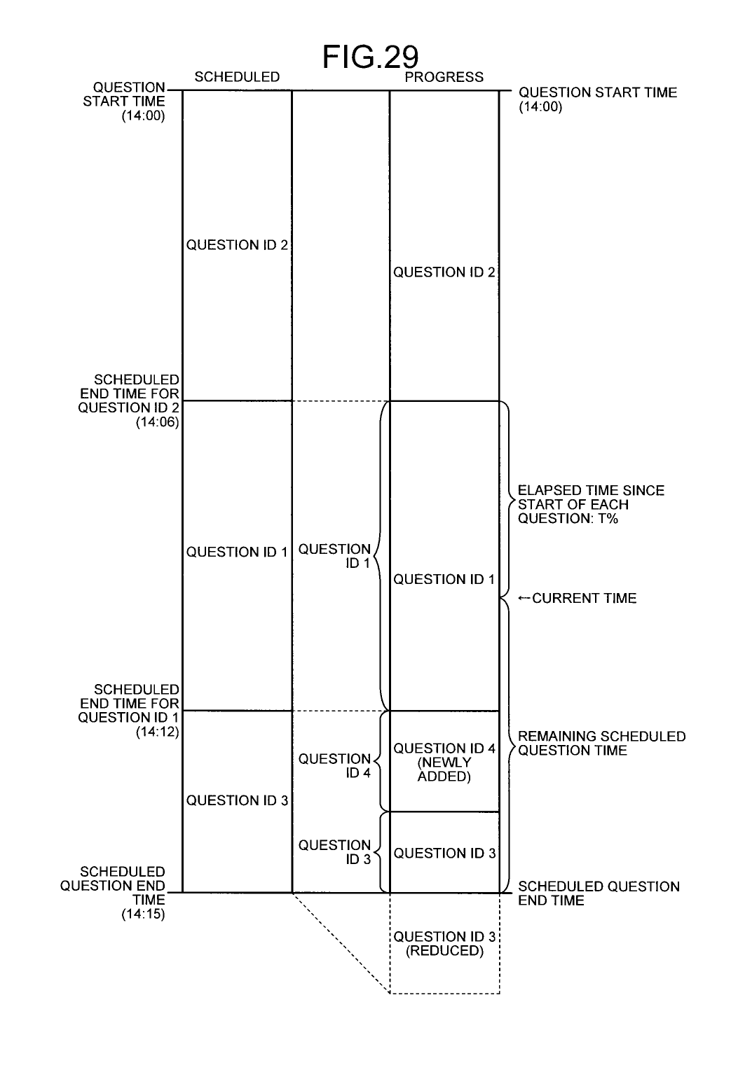

FIG. 29 is a diagram illustrating an example of the rescheduling process performed when “Priority-based reduction” is selected (in connection with FIG. 28). In the example in FIG. 29, the elapsed time of the current question ID 1 is shorter than the rescheduling start threshold set in advance; therefore, the questions with the question IDs 1, 4, and 3 become the subjects of the rescheduling. The page managing unit 105 sets the reduction time of each of the questions with the question IDs 1, 4, and 3 in accordance with the priorities of the respective questions so that the questions can be displayed within the question-and-answer time set in advance. In the example in FIG. 29, because the priority of the question ID 3 is lowest, the display duration of the question ID 3 is to be reduced by the longest reduction time.

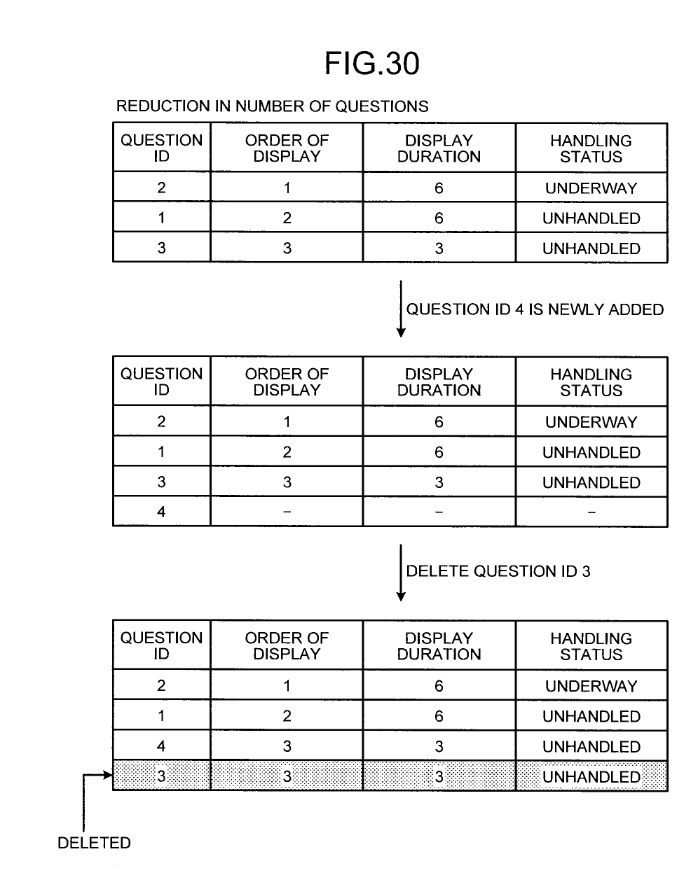

FIG. 30 is a diagram for explaining the overview of the rescheduling process performed when “Reduction in the number of questions” is selected. In the example in FIG. 30, it is assumed that the question with the question ID 4 is added. The page managing unit 105 determines the order of display by referring to the priority information (the weighting information) contained in the question information of each of the question IDs 1 to 4 and also determines the display duration of the question ID 4. The display duration of the question ID 4 is determined by, for example, the method explained with reference to FIG. 13. The page managing unit 105 performs the number-of-questions reduction process illustrated in FIG. 20 to delete a question having the lowest priority so that the questions can be displayed within the question-and-answer time set in advance. Consequently, the schedule table is adjusted. In the example in FIG. 30, the question ID 3 having the lowest priority is deleted from the schedule table.

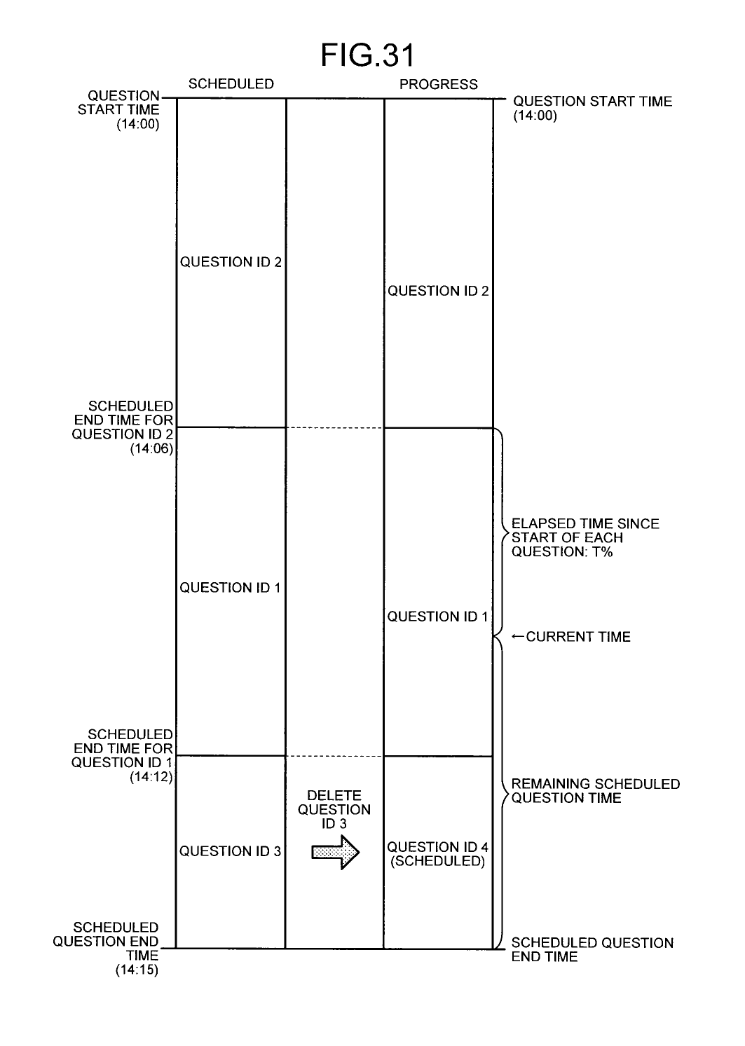

FIG. 31 is a diagram illustrating an example of the rescheduling process performed when “Reduction in the number of questions” is selected (in connection with FIG. 30). In the example in FIG. 31, the elapsed time of the current question ID 1 is shorter than the rescheduling start threshold set in advance; therefore, the questions with the question IDs 1, 4, and 3 become the subjects of the rescheduling. The page managing unit 105 deletes a question having the lowest priority among the unhandled questions (the question IDs 1, 4, and 3) so that the questions can be displayed within the question-and-answer time set in advance. In the example in FIG. 31, the question ID 3 having the lowest priority is deleted.

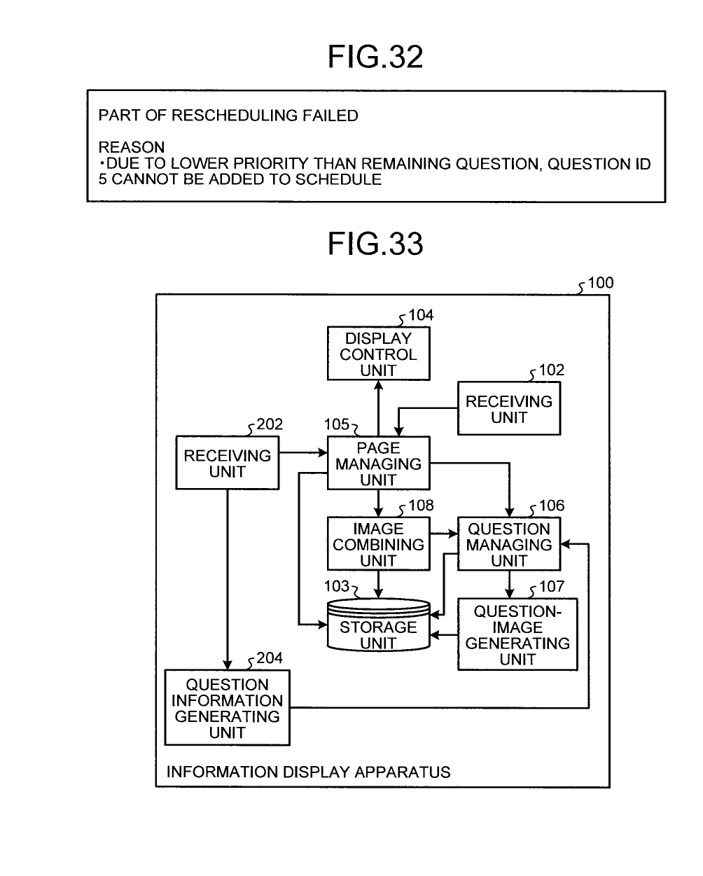

FIG. 32 is a diagram illustrating a display example for notifying that a part of rescheduling has failed (Step S54 in FIG. 15) in the rescheduling process described above (the rescheduling performed when new question information is received from the question input apparatus 200 after the schedule table is generated). In the example in FIG. 32, it is displayed that a part of questions cannot be handled because of lack of the remaining question time. In this example, it is indicated that the additional question (a question with a question ID 5) cannot be added to the schedule because the priority of the question ID 5 is lower than the priorities of the remaining questions.

As described above, according to the embodiment, when there is a difference between the display duration shown in the schedule table and the actual display duration or when an additional question is issued after generation of the schedule table, in which the order of displaying the questions and the display durations of the respective questions are associated with each other, the schedule table is adjusted. Therefore, it is advantageous in that the question-and-answer session can be performed with efficiency.

Each of the information display apparatus 100 and the question input apparatus 200 of the embodiment has a hardware configuration using a normal computer including a control device, such as a central processing unit (CPU); a storage device, such as a read only memory (ROM) or a random access memory (RAM); and an external storage device, such as a hard disk drive (HDD) or a compact disc (CD)-drive.

A program executed by the information display apparatus 100 or the question input apparatus 200 of the embodiment is provided by being recorded in a computer-readable recording medium, such as a CD-ROM, a flexible disk (FD), a CD-R, or a digital versatile disk (DVD), in a computer-installable or a computer-executable file format.

The program executed by the information display apparatus 100 or the question input apparatus 200 of the embodiment may be stored in a computer connected to a network, such as the Internet, so as to be provided by being downloaded via the network. The program executed by the information display apparatus 100 of the embodiment may be provided or distributed via a network, such as the Internet.

The program of the embodiment may be provided by being installed in a ROM or the like in advance.

The program executed by the information display apparatus 100 has a module structure made of the above-mentioned units (the communication unit 101, the receiving unit 102, the display control unit 104, the page managing unit 105, the question managing unit 106, the question-image generating unit 107, and the image combining unit 108). As actual hardware, the CPU (processor) reads the program from the above recording medium and executes the program to load the above units on the main storage device, thereby generating the communication unit 101, the receiving unit 102, the display control unit 104, the page managing unit 105, the question managing unit 106, the question-image generating unit 107, and the image combining unit 108 on the main storage device. The storage unit 103 is an element realized by hardware, and is constructed of a ROM, a RAM, or an external storage device. The program executed by the question input apparatus 200 has a module structure made of the above-mentioned units (the communication unit 201, the receiving unit 202, the display control unit 203, and the question information generating unit 204). As actual hardware, the CPU (processor) reads the program from the above recording medium and executes the program to load the above units on the main storage device, thereby generating the communication unit 201, the receiving unit 202, the display control unit 203, and the question information generating unit 204 on the main storage device.

In the embodiment, the information display system 400 is configured such that the information display apparatus 100 and the question input apparatus 200 are connected to the network 300; however, it is not limited thereto. For example, as illustrated in FIG. 33, the information display apparatus 100 may include the functions of the question input apparatus 200.

According to the embodiment, it is advantageous in that a question-and-answer session can efficiently be performed within a predetermined time.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information display apparatus that communicates with a question input apparatus for inputting a question, the information display apparatus comprising:
a receiving unit configured to receive the question;
a storage unit configured to store therein the question;
a display control unit configured to control display of the question;
a request receiving unit configured to receive a display request to display the question;
a generating unit configured to, in response to the display request received by the request receiving unit, generate a schedule table in which an order of displaying questions stored in the storage unit and display durations of the respective questions are associated with each other so that a sum of the display durations of the questions becomes equal to or shorter than a question-and-answer time indicating a predetermined duration of a question-and-answer session; and
a notifying unit configured to issue a notice of a timing at which each of the display durations ends based on the schedule table, wherein
when receiving a switching request to request switching between the questions, the display control unit switches display of the questions in accordance with the order indicated in the schedule table, and
when a predetermined condition is satisfied after the schedule table is generated, the generating unit adjusts the schedule table.

2. The information display apparatus according to claim 1, wherein the predetermined condition is that a difference between a display duration of a question contained in the schedule table and an actual display duration of the question exceeds a threshold.

3. The information display apparatus according to claim 2, wherein when adjusting the schedule table, the generating unit equally reduces the display durations of questions that have not been displayed.

4. The information display apparatus according to claim 2, wherein when adjusting the schedule table, the generating unit reduces the display durations of questions that have not been displayed so that the display duration of a question having a lower priority is reduced by a longer time.

5. The information display apparatus according to claim 2, wherein when adjusting the schedule table, the generating unit deletes a question having the lowest priority among questions that have not been displayed from the schedule table.

6. The information display apparatus according to claim 1, wherein the predetermined condition is that the receiving unit receives a new question after the generating unit has generated the schedule table.

7. The information display apparatus according to claim 6, wherein when adjusting the schedule table, the generating unit equally reduces the display durations of questions that have not been displayed.

8. The information display apparatus according to claim 6, wherein when adjusting the schedule table, the generating unit reduces the display durations of questions that have not been displayed so that the display duration of a question having a lower priority is reduced by a longer time.

9. The information display apparatus according to claim 6, wherein when adjusting the schedule table, the generating unit deletes a question having the lowest priority among questions that have not been displayed from the schedule table.

10. The information display apparatus according to claim 1, wherein the generating unit generates the schedule table so that a question having a higher priority is displayed earlier and for a longer duration.

11. An information display apparatus comprising:
a first receiving unit configured to receive a question;
a storage unit configured to store therein the question;
a display control unit configured to control display of the question;
a second receiving unit configured to receive a display request to display the question;
a generating unit configured to, in response to the display request received by the second receiving unit, generate a schedule table in which an order of displaying questions stored in the storage unit and display durations of the respective questions are associated with each other so that a sum of the display durations of the questions becomes equal to or shorter than a question-and-answer time indicating a predetermined duration of a question-and-answer session; and
a notifying unit configured to issue a notice of a timing at which each of the display durations ends based on the schedule table, wherein
when receiving a switching request to request switching between the questions, the display control unit switches display of the questions in accordance with the order indicated in the schedule table, and
when a predetermined condition is satisfied after the schedule table is generated, the generating unit adjusts the schedule table.

12. An information display method comprising:
receiving a question;
storing the question in a storage unit;
controlling display of the question;
receiving a display request to display the question;
generating, in response to the display request received, a schedule table in which an order of displaying questions stored in the storage unit and display durations of the respective questions are associated with each other so that a sum of the display durations of the questions becomes equal to or shorter than a question-and-answer time indicating a predetermined duration of a question-and-answer session; and
issuing a notice of a timing at which each of the display durations ends based on the schedule table, wherein
the controlling includes switching, when receiving a switching request to request switching between the questions, display of the questions in accordance with the order indicated in the schedule table, and
the generating includes adjusting the schedule table when a predetermined condition is satisfied after the schedule table is generated.

13. The information display method according to claim 12, wherein the predetermined condition is that a difference between a display duration of a question contained in the schedule table and an actual display duration of the question exceeds a threshold.

14. The information display method according to claim 13, wherein the generating includes equally reducing, when adjusting the schedule table, the display durations of questions that have not been displayed.

15. The information display method according to claim 13, wherein the generating includes reducing, when adjusting the schedule table, the display durations of questions that have not been displayed so that the display duration of a question having a lower priority is reduced by a longer time.

16. The information display method according to claim 13, wherein the generating includes deleting, when adjusting the schedule table, a question having the lowest priority among questions that have not been displayed from the schedule table.

17. The information display method according to claim 12, wherein the predetermined condition is that the receiving unit receives a new question after the generating unit has generated the schedule table.

18. The information display method according to claim 17, wherein the generating includes equally reducing, when adjusting the schedule table, the display durations of questions that have not been displayed.

19. The information display method according to claim 17, wherein the generating includes reducing, when adjusting the schedule table, the display durations of questions that have not been displayed so that the display duration of a question having a lower priority is reduced by a longer time.

20. The information display method according to claim 12, wherein the generating includes generating the schedule table so that a question having a higher priority is displayed earlier and for a longer duration.
